(19) United States
(12) Patent Application Publication
(10) Pub. No.: US 2017/0178467 A1
(43) Pub. Date: Jun. 22, 2017

(54) POINTING DEVICE FOR SHOWCASES

(71) Applicant: "Fredl's Glaserei" Amir Avdic e.U., Seeboden (AT)

(72) Inventor: Amir AVDIC, Seeboden (AT)

(21) Appl. No.: 15/386,896

(22) Filed: Dec. 21, 2016

(30) Foreign Application Priority Data
Dec. 22, 2015 (AT) A 813/2015

(51) Int. Cl. G08B 5/36; F21V 21/096; F21V 23/04; F21V 21/14

(52) U.S. Cl. CPC G08B 5/36; F21V 21/14; F21V 21/096; F21V 23/04; F21Y 2115/30

(57) ABSTRACT

A pointing device (1) for generating light spots on a ware that is arranged in a showcase includes a part (3) that is arranged on the outside of the showcase panel (2), on which a light source (8) with an activating switch (11) is mounted. The device (1) also includes a part (4) that is arranged on the inside of the showcase panel (2) and has a hole (10) for the passage of the light beam (9), which is generated by the light source (8). The parts (3) and (4) of the device (1) are held together by magnetic forces and rest on the showcase panel (2) via sliding surfaces (6).

### FIELD OF THE INVENTION

The invention relates to a pointing device for showcases with the features of the introductory part of claim 1.

### BACKGROUND OF THE INVENTION

The problem of identifying wares provided in showcases often arises. Pointing to wares with one's finger is problematic, since the salesperson in general does not know exactly at which ware the customer is pointing.

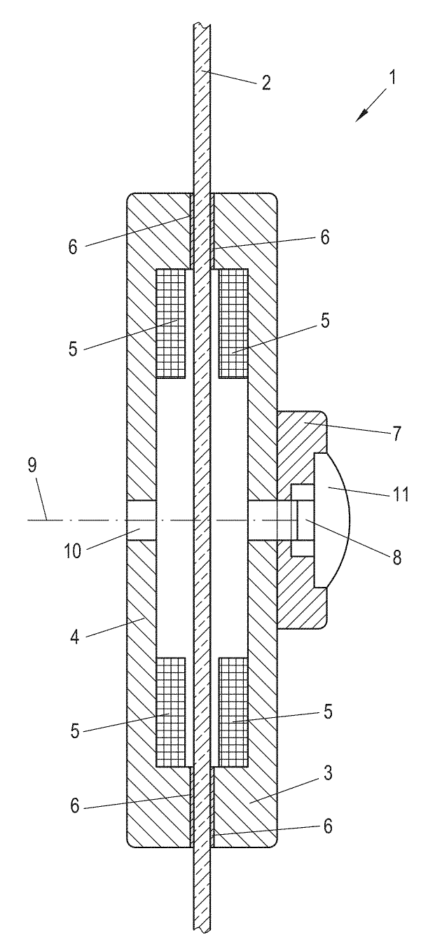

It is known from GB 353,890 A that in the case of a vending machine, a light source is to be provided that illuminates the item selected by a dial similar to a telephone dial. As shown in FIG. 8 and explained on page 7, lines 87 to 100 and 106 to 124 of GB 353,890 A, the lamp-like light source is pivoted via a cam disk control, in such a way that it illuminates the selected item.

EP 2 662 618 A1 describes and shows a rod-shaped aquarium lamp, which has a fastening part. The fastening part consists of two segments, which are held together by magnetic forces. A glass panel is provided between the segments. The light emitted by the lamp does not pass through the segments of the fastening part.

US 2011/0233228 A1 relates to a vending machine, to which a pointing device that is similar to that of GB 353,890 A is assigned. A ball is provided as a control for the pointing device, so that the desired item can be highlighted. Only then is the purchase made.

### SUMMARY OF THE INVENTION

The object of the invention is to indicate a device that in a simple way can point to the ware that is contained in a showcase and that the customer wants to purchase.

This object is achieved according to the invention with a device that has the features of claim 1.

Advantageous and preferred configurations of the device according to the invention are subjects of the subclaims.

Since the device according to the invention, “pointing device,” is equipped with a source of a light beam and is mounted on the showcase panel is a movable way, the customer can create a light dot on the desired ware by moving the pointing device and activating the light source so that the salesperson can easily see what the customer would like to purchase.

The light source can be, for example, a laser beam, which is generated with a laser source similar to a laser pointer.

Holding the device on the panel, e.g., the glass plate, of a showcase is done in the case of the invention using magnetic forces, whereby one magnet is arranged on the outer side and the second magnet is arranged on the inner side of the showcase panel.

Additional details and features of the invention follow from the description below of a preferred embodiment based on the drawing, in which a device according to the invention is diagrammatically depicted in section.

### BRIEF DESCRIPTION OF THE DRAWINGS

The FIGURE shows a pointing device for generating light spots on a ware that is arranged in a showcase.

### DETAILED DESCRIPTION OF THE DRAWING EMBODIMENT

In the embodiment shown in the drawing, the device 1 according to the invention comprises a part 3 that is arranged outside of the showcase panel 2 and a part 4 that is arranged inside of the showcase panel 2. In the part 3 that is arranged outside of the showcase panel 2 and in the part 4 that is arranged inside of the showcase panel 2, magnets 5, for example annular magnets, with opposite polarities are arranged in such a way that the magnets 5 mutually attract and thus hold on the showcase panel 2 the part 3 that is arranged on the outside of the showcase panel 2 and the part 4 that is arranged on the inside of the showcase panel 2.

In order to avoid a scratching of the showcase panel 2 and to easily configure the movement of the device 1, sliding surfaces 6, for example in the form of felt cushions, are provided in the surfaces of the parts 3 and 4 that rest on the showcase panel 2.

On the part 3 that is arranged on the outside of the showcase panel 2, a housing 7 is mounted, in which housing a laser source 8, for example a laser pointer, is installed. The light source 8, e.g., the laser pointer, generates a light beam (laser beam) 9, which passes through the showcase panel 2 and through a hole 10 in the part 4 and on the ware that is desired by the customer, i.e., the ware that corresponds to the position of the device 1 according to the invention generates a light spot.

To activate the light source 8, i.e., to generate the light beam 9, a push switch 11 (button) is provided on the housing 7 of the outer part 4 of the device 1 according to the invention.

It can be seen that by moving the device 1 according to the invention along the showcase panel 2, optionally with an already activated laser pointer 8, a light spot can easily be generated on the ware that a customer wants to purchase.

In summary, an embodiment of the invention can be described, for example, as follows:

A pointing device 1 for generating light spots on a ware that is arranged in a showcase comprises a part 3 that is arranged on the outside of the showcase panel 2, in which a light source 8 with a switch 11 is mounted. The device 1 also comprises a part 4 that is arranged on the inside of the showcase panel 2 and has a hole 10 for the passage of the light beam 9, which is generated by the light source 8. The parts 3 and 4 of the device 1 according to the invention are held together by magnetic forces and rest on the showcase panel 2 via sliding surfaces 6.

1. Device (1) for generating a light spot on a ware that is arranged in a showcase behind a showcase panel (2), with a light source (8) of a light beam (9) that is to be focused on a ware, wherein the light source (8) of the light beam (9) is arranged in a movable fashion on the showcase panel (2), a part (3) that rests on the outside of the showcase panel (2) and a part (4) that rests on the inside of the showcase panel (2) being provided, the parts (3 and 4) being held by magnetic forces attached to the outside and the inside of the showcase panel (2), the light source (8) being arranged in a housing (7), which is arranged on the part (3) of the device (1) that rests on the outside of the showcase panel (2), and wherein a hole (10) for the light beam (9) is provided in the part (4) that rests on the inside of the showcase panel (2).

2. Device according to claim 1, wherein the light beam is a laser beam (9), which starts from a laser source that is arranged on the device (1).

3. Device according to claim 1, wherein for generating the magnetic forces, annular magnets (5) are provided, which magnets are inserted into the parts (3 and 4).

4. Device according to claim 1, wherein sliding surfaces (6) are provided in the surfaces of the parts (3 and 4) that rest on the showcase panel (2).

5. Device according to claim 4, wherein the sliding surfaces (6) are felt cushions.

6. Device according to claim 1, wherein the housing (7) has a switch (11), in particular a push switch, for activating the light source (8), in particular the laser source.

7. Device according to claim 1, wherein the parts (3 and 4) are designed essentially flat and shell-shaped.

8. Device according to claim 2, wherein for generating the magnetic forces, annular magnets (5) are provided, which magnets are inserted into the parts (3 and 4).

9. Device according to claim 2, wherein sliding surfaces (6) are provided in the surfaces of the parts (3 and 4) that rest on the showcase panel (2).

10. Device according to claim 3, wherein sliding surfaces (6) are provided in the surfaces of the parts (3 and 4) that rest on the showcase panel (2).

11. Device according to claim 2, wherein the housing (7) has a switch (11), in particular a push switch, for activating the light source (8), in particular the laser source.

12. Device according to claim 3, wherein the housing (7) has a switch (11), in particular a push switch, for activating the light source (8), in particular the laser source.

13. Device according to claim 4, wherein the housing (7) has a switch (11), in particular a push switch, for activating the light source (8), in particular the laser source.

14. Device according to claim 5, wherein the housing (7) has a switch (11), in particular a push switch, for activating the light source (8), in particular the laser source.

15. Device according to claim 2, wherein the parts (3 and 4) are designed essentially flat and shell-shaped.

16. Device according to claim 3, wherein the parts (3 and 4) are designed essentially flat and shell-shaped.

17. Device according to claim 4, wherein the parts (3 and 4) are designed essentially flat and shell-shaped.

18. Device according to claim 5, wherein the parts (3 and 4) are designed essentially flat and shell-shaped.

19. Device according to claim 6, wherein the parts (3 and 4) are designed essentially flat and shell-shaped.

20. Device according to claim 14, wherein the parts (3 and 4) are designed essentially flat and shell-shaped.
